(19) United States
(12) Patent Application Publication
(10) Pub. No.: US 2010/0012431 A1
(43) Pub. Date: Jan. 21, 2010

(54) Tire step apparatus

(76) Inventor: Steve L. Ehnes, Lebanon, MO (US)

Correspondence Address: HUSCH BLACKWELL SANDERS LLP, 4801 Main Street, Suite 1000, KANSAS CITY, MO, 64112, US

(21) Appl. No.: 12/154,393

(22) Filed: May 23, 2008

(51) Int. Cl. E06C 5/00

(52) U.S. Cl. 182/150

(57) ABSTRACT

A step apparatus is provided for use on a vehicle tire and includes a first step assembly which includes a first step portion and a pair of first struts extending upward from the first step portion. A second step assembly includes a second step portion. A pair of first bracket members partially support the second step portion, and a pair of second bracket members are telescopically adjustably connected to the pair of first bracket members. Hinge members are connected between the first struts and the front bracket portions. Locking means are provided for locking the first bracket members with respect to the second bracket members at a selected adjustment position, depending upon the width of the tire on which the apparatus is used. By adjusting the first bracket members and the second bracket members with respect to each other, the present apparatus can be used for a wide range of tires having a wide range of tire widths.

### BACKGROUND OF THE INVENTION

1. Field of the Invention

The present invention relates generally to tire step apparatuses, such as disclosed in U.S. Pat. Nos. 6,457,558 and 6,957,719, by the same inventor of the current invention.

2. Description of the Prior Art

The most relevant prior art are U.S. Pat. Nos. 6,457,558 and 6,957,719, by the same inventor of the current invention. In this respect, U.S. Pat. Nos. 6,457,558 and 6,957,719 are incorporated herein by reference.

It is noted that in U.S. Pat. Nos. 6,457,558 and 6,957,719, the brackets which fit over the vehicle tire have a fixed width. However, it is well known that various tires for various vehicles have various widths. In this respect, it would be desirable if a tire step apparatus were provided which had adjustable bracket portions to be adjusted to fit a various tires having various tire widths.

It is also noted in U.S. Pat. Nos. 6,457,558 and 6,957,719, that step-to-wheel support members 50 have a relatively small surface area for contacting wheels or tires when the tire step apparatus is deployed on a tire. If a greater surface area were provided for contacting a wheel and tire when the tire step apparatus were deployed on a tire, then there would be greater stability on the wheel and tire for a person stepping on and using the tire step apparatus. In this respect, it would be desirable if a tire step apparatus were provided which included a relatively large surface area for contacting a wheel and tire when the tire step apparatus is deployed on a wheel and tire.

Still other features would be desirable in a tire step apparatus. For example, U.S. Pat. Nos. 6,457,558 and 6,957,719 disclose a maximum of three step assemblies. For taller tires, such as on military vehicles, it would be desirable if a tire step apparatus had four step assemblies.

Thus, while the foregoing body of prior art indicates it to be well known to use tire step apparatuses, the prior art described above does not teach or suggest a tire step apparatus which has the following combination of desirable features: (1) has adjustable bracket portions to be adjusted to fit various tires having various tire widths; (2) includes a relatively large surface area for contacting a wheel and tire when the tire step apparatus is deployed on a wheel and tire; and (3) can have four step assemblies especially useful for very tall tires, such as on military vehicles.

The foregoing desired characteristics are provided by the unique tire step apparatus of the present invention as will be made apparent from the following description thereof. Other advantages of the present invention over the prior art also will be rendered evident.

### SUMMARY OF THE INVENTION

To achieve the foregoing and other advantages, the present invention, briefly described, provides a step apparatus for use a vehicle tire and includes a first step assembly which includes a first step portion and a pair of first struts extending upward from the first step portion. A second step assembly includes a second step portion. A pair of first bracket members partially support the second step portion, and a pair of second bracket members are adjustably connected to the pair of first bracket members. Hinge members are connected between the first struts and the front bracket portions. Preferably, a pair of pawl assemblies are connected to the rear bracket portions.

Preferably, the pair of second bracket members are telescopically received in the pair of first bracket members.

Locking means are provided for locking the first bracket members with respect to the second bracket members when an adjusted position is selected. The locking means can include a locking bolt and a locking nut.

Preferably, each of the first struts includes a stop member for contacting the tire when the apparatus is installed on the tire.

The first bracket members have a first bracket vertical length. The first struts have a first strut vertical length. The first strut vertical length is greater than the first bracket vertical length, whereby the first step portion is placed in registration with the second step portion when the first step assembly is placed in a storage orientation or condition with respect to the second step portion.

Each of the pawl assemblies includes a pawl bias spring which is connected between the rear bracket portion and the pawl plate. Each pawl plate includes pawl teeth located on an outside edge of the pawl plate. Each pawl plate includes a pawl handle for manually operating the pawl plate. Each of the bias springs is connected between a respective pawl handle and a respective stop member.

A third step assembly is connected to the first step assembly by means of additional hinge members. The third step assembly includes a third step portion and a pair of second struts extending upward from the third step portion. The third step assembly includes second stop members attached to the first struts of the first step assembly. Step-to-wheel support members are connected to the first step assembly.

In addition, a wheel and tire spanning bar is connected to the step-to-wheel support members.

A fourth step assembly is connected to the third step assembly by means of additional hinge members. The fourth step assembly includes a fourth step portion and a pair of third struts extending upward from the fourth step portion. The fourth step assembly includes third stop members attached to the second struts of the third step assembly.

The above brief description sets forth rather broadly the more important features of the present invention in order that the detailed description thereof that follows may be better understood, and in order that the present contributions to the art may be better appreciated. There are, of course, additional features of the invention that will be described hereinafter and which will be for the subject matter of the claims appended hereto.

In this respect, before explaining at least two preferred embodiments of the invention in detail, it is understood that the invention is not limited in its application to the details of the construction and to the arrangements of the components set forth in the following description or illustrated in the drawings. The invention is capable of other embodiments and of being practiced and carried out in various ways. Also, it is to be understood, that the phraseology and terminology employed herein are for the purpose of description and should not be regarded as limiting.

As such, those skilled in the art will appreciate that the conception, upon which disclosure is based, may readily be utilized as a basis for designing other structures, methods, and systems for carrying out the several purposes of the present invention. It is important, therefore, that the claims be regarded as including such equivalent constructions insofar as they do not depart from the spirit and scope of the present invention.

It is therefore an object of the present invention to provide a new and improved tire step apparatus which has all of the advantages of the prior art and none of the disadvantages.

It is another object of the present invention to provide a new and improved tire step apparatus which may be easily and efficiently manufactured and marketed.

It is a further object of the present invention to provide a new and improved tire step apparatus which is of durable and reliable construction.

An even further object of the present invention is to provide a new and improved tire step apparatus which is susceptible of a low cost of manufacture with regard to both materials and labor, and which accordingly is then susceptible of low prices of sale to the consuming public, thereby making such tire step apparatus available to the buying public.

Still yet a further object of the present invention is to provide a new and improved tire step apparatus which has adjustable bracket portions to be adjusted to fit a various tires having various tire widths.

Still another object of the present invention is to provide a new and improved tire step apparatus which includes a relatively large surface area for contacting a wheel and tire when the tire step apparatus is deployed on a wheel and tire.

Yet another object of the present invention is to provide a new and improved tire step apparatus which has four step assemblies, which is especially useful for very tall tires, such as on military vehicles.

These together with still other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

The invention will be better understood and the above objects as well as objects other than those set forth above will become more apparent after a study of the following detailed description thereof. Such description makes reference to the annexed drawing wherein:

FIG. 1 is a front perspective view showing a first embodiment of the tire step apparatus of the invention installed on a vehicle tire.

FIG. 2 is a rear perspective view of the embodiment of the invention shown in FIG. 1.

FIG. 3 is a top view of the embodiment of the invention shown in FIGS. 1 and 2.

FIG. 4 is a side view of the embodiment of the invention shown in FIG. 3, taken along line 4-4 thereof.

FIG. 5 is a front view of the embodiment of the invention shown in FIG. 4, taken along line 5-5 thereof.

FIG. 6 is an enlarged view of the portion of the invention shown in circled region 6 of FIG. 4.

FIG. 7 is an enlarged cross-sectional view of the portion of the embodiment shown in FIG. 4, taken along line 7-7 thereof.

FIG. 8 is an enlarged perspective view of the first step assembly of FIG. 1, removed from the remainder of the embodiment.

FIG. 9 is a side view of the embodiment of the invention shown in FIG. 4, with the tire step apparatus in a folded up condition in solid lines and in an unfolded condition in broken lines.

FIG. 10 is a side view of a second embodiment of the invention which includes a fourth step assembly.

### DESCRIPTION OF THE PREFERRED EMBODIMENT

With reference to the drawings, a new and improved tire step apparatus embodying the principles and concepts of the present invention will be described.

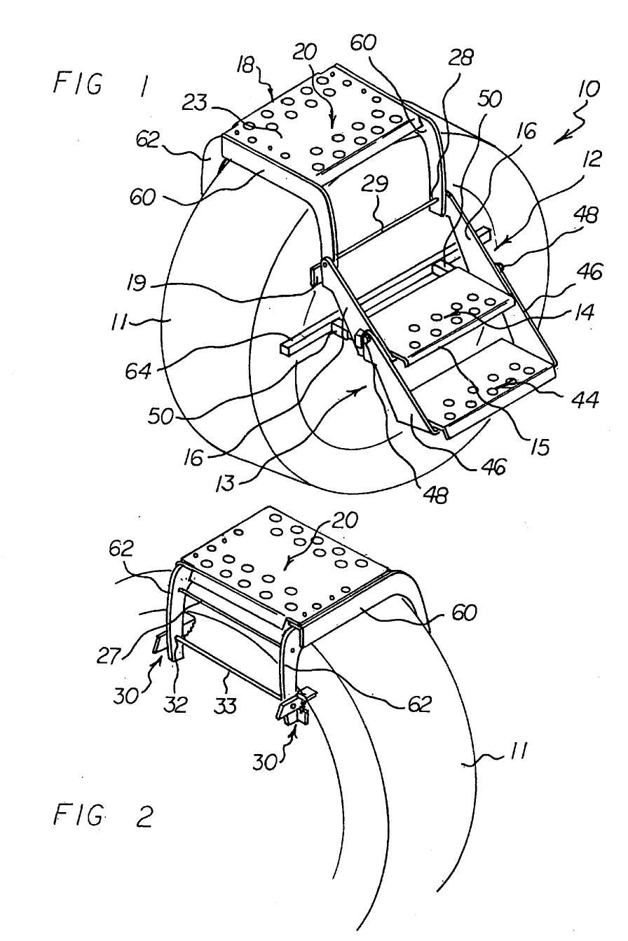

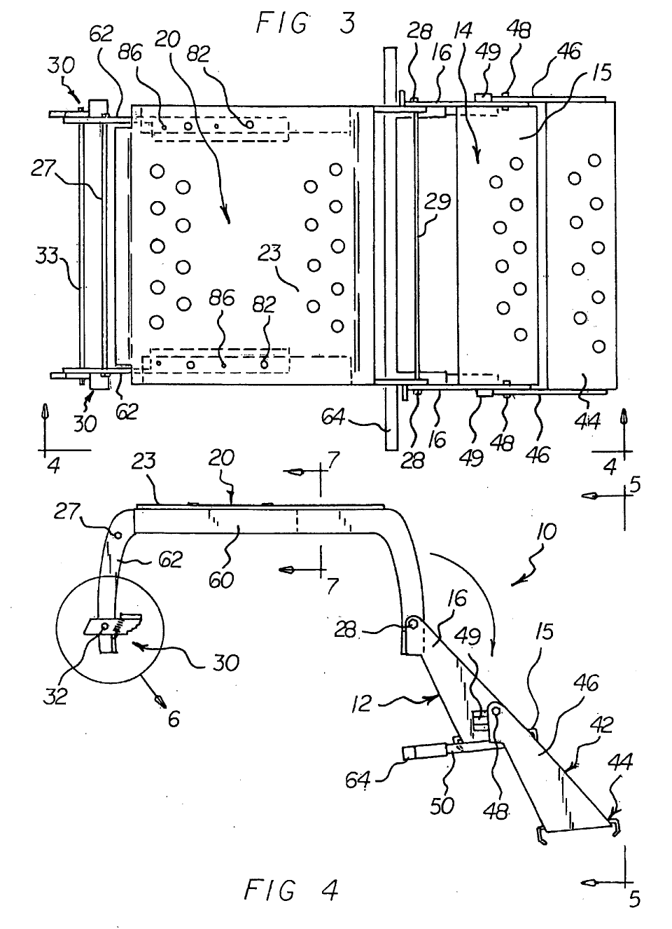

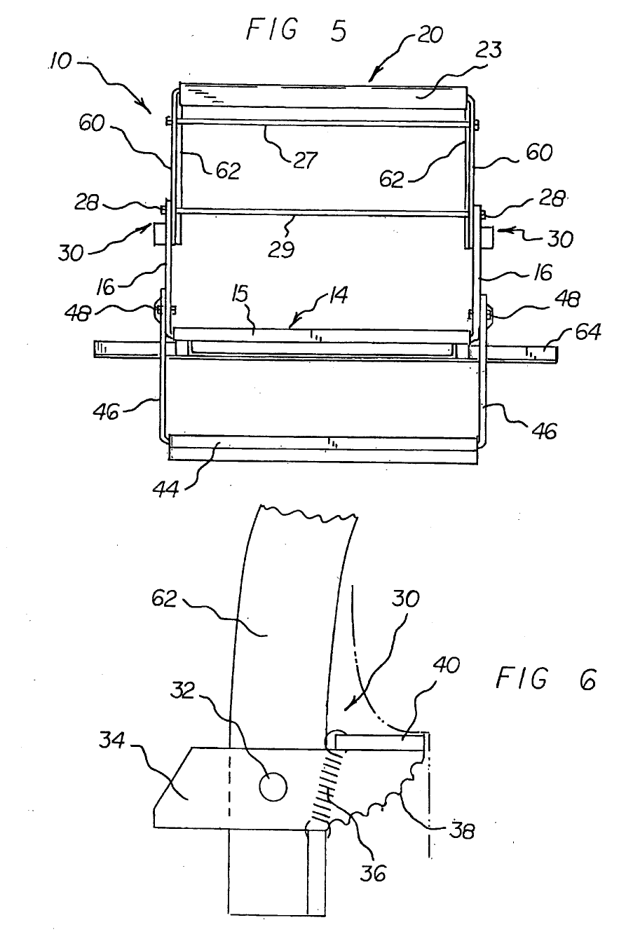

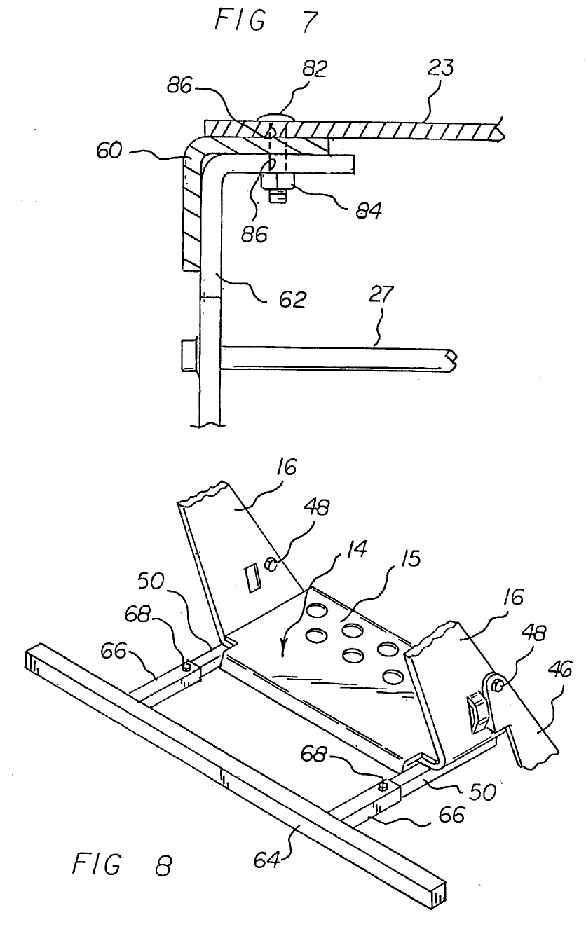

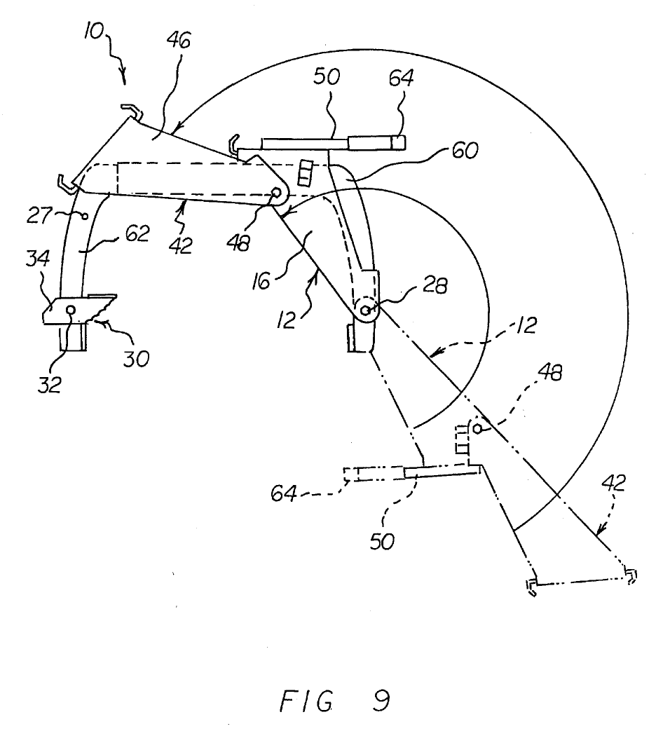

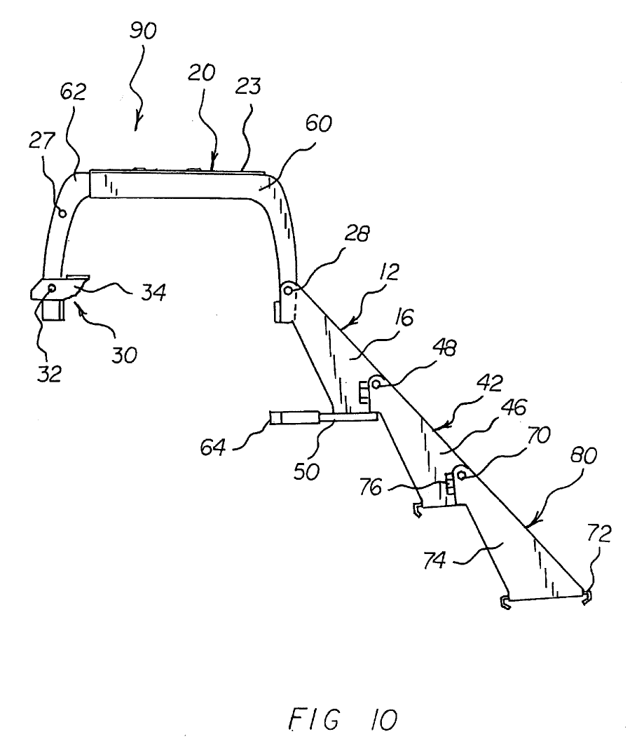

Turning to FIGS. 1-9, there is shown a first embodiment of the tire step apparatus of the invention generally designated by reference numeral 10. In each of the figures, reference numerals are shown that correspond to like reference numerals that designate like elements shown in other figures. As stated above, U.S. Pat. Nos. 6,457,558 and 6,957,719 are incorporated herein by reference.

In the first embodiment, a step apparatus 10 is provided for use a vehicle tire 11 and includes a first step assembly 12 which includes a first step portion 14 and a pair of first struts 16 extending upward from the first step portion 14. A second step assembly 18 which includes a second step portion. A pair of first bracket members 60 partially supporting the second step portion 20, and a pair of second bracket members 62 is adjustably connected to the pair of first bracket members 60, hinge members 28 is connected between the first struts 16 and the front bracket portions 24. Preferably, a pair of pawl assemblies 30 are connected to the rear bracket portions 26.

Preferably, the pair of second bracket members 62 are telescopically received in the pair of first bracket members 60.

Locking means are provided for locking the first bracket members 60 with respect to the second bracket members 62. The locking means includes a locking bolt 82 and a locking nut 84. In this respect, each of the second tread plate 23, the first bracket members 60, and the second bracket members 62 includes a respective series of bolt-reception channels 86 for receiving the locking bolt 82 for locking the first bracket members 60 with respect to the second bracket members 62.

A first tread plate 15 is attached to the first step portion 14. Also, the hinge members 28 are located at the ends of hinge axle 29 which extends between a pair of hinge members 28. A brace member 27 is connected between the pair of second bracket members 62.

The pawl hinges 32 are located at the ends of pawl axle 33 which extends between a pair of pawls. Also, there are plural brace members 27 which are in the form of right-angled struts. Also, the hinge members 28 are located at the ends of hinge axle 29 which extends between a pair of hinge members 28.

To determine which of the series of bolt-reception channels 86 to employ for the locking bolt 82, a user can measure the width of the tire 11 onto which the tire step apparatus 10 of the invention is to be installed. Then, the user can adjust the first bracket members 60 and the second bracket members 62, by telescopically sliding them with respect to each other, so that the spacing between them will accommodate the tire 11. Then, the user inserts the locking bolt 82 through the respective bolt-reception channels 86 which are in registration, and the user thereby locks the first bracket members 60 and the second bracket members 62 together in the selected positions. The locking nut 84 is then used to secure the locking bolt 82 to the tire step apparatus 10.

Preferably, each of the first struts 16 includes a stop member 19 for contacting the tire 11 when the apparatus is installed on the tire 11.

The first bracket members 60 have a first bracket vertical length. The first struts 16 have a first strut vertical length. The first strut vertical length is greater than the first bracket vertical length, whereby the first step portion 14 is placed in registration with the second step portion 20 when the first step assembly 12 is placed in a storage orientation or condition with respect to the second step portion 20.

Each of the pawl assemblies 30 includes a pawl bias spring 36 is connected between the rear bracket portion 26 and the pawl plate 34. Each pawl plate 34 includes pawl teeth 38 located on an outside edge of the pawl plate 34. Each pawl plate 34 includes a pawl handle 40 for manually operating the pawl plate 34. Each of the bias springs 36 is connected between a respective pawl handle 40 and a respective stop member 19.

A third step assembly 42 is connected to the first step assembly 12 by means of additional hinge members 48. The third step assembly 42 includes a third step portion 44 and a pair of second struts 46 extending upward from the third step portion 44. The third step assembly 42 includes second stop members 49 attached to the first struts 16 of the first step assembly 12. Step-to-wheel support members 50 are connected to the first step assembly 12.

In addition, a wheel and tire spanning bar 64 is connected to the step-to-wheel support members 50. With the wheel and tire spanning bar 64 attached to the step-to-wheel support members 50, such as with sleeves 66 that are attached to the step-to-wheel support members 50 using bolts 68, the wheel and tire spanning bar 64 spans across both the wheel 13 and the tire 11 which is mounted on the wheel 13. In this way, when a person is standing on the tire step apparatus 10 of the invention, the person's forward leaning component of his weight is distributed over the wheel and tire spanning bar 64, which has a relatively large surface area, in comparison with the step-to-wheel support members 50 which have a relatively small surface area. This larger surface area of weight distribution serves to stabilize the tire step apparatus 10 against the wheel 13 and the tire 11, thereby steadying the tire step apparatus 10 when the person climbs and stands on the tire step apparatus 10.

As shown in FIG. 10, a second embodiment of the invention 90 includes fourth step assembly 80 is connected to the third step assembly 42 by means of additional hinge members 70. The fourth step assembly 80 includes a fourth step portion 72 and a pair of third struts 74 extending upward from the fourth step portion 72. The fourth step assembly 80 includes third stop members 76 attached to the second struts 46 of the third step assembly 42. The fourth step assembly 80 is especially useful for tall tires, such as on military vehicles.

As to the manner of usage and operation of the instant invention, the same is apparent from the above disclosure, and accordingly, no further discussion relative to the manner of usage and operation need be provided.

It is apparent from the above that the present invention accomplishes all of the objects set forth by providing a new and improved tire step apparatus that is low in cost, relatively simple in design and operation, and which may advantageously be used to provide adjustable bracket portions to be adjusted to fit a various tires having various tire widths. Also, with the invention, a tire step apparatus is provided which has a relatively large surface area for contacting a wheel and tire when the tire step apparatus is deployed on a wheel and tire.

In addition, with the invention, a tire step apparatus can be provided which has four step assemblies, which is especially useful for very tall tires, such as on military vehicles.

Thus, while the present invention has been shown in the drawings and fully described above with particularity and detail in connection with what is presently deemed to be the most practical and preferred embodiment(s) of the invention, it will be apparent to those of ordinary skill in the art that many modifications thereof may be made without departing from the principles and concepts set forth herein, including, but not limited to, variations in size, materials, shape, form, function and manner of operation, assembly and use.

Hence, the proper scope of the present invention should be determined only by the broadest interpretation of the appended claims so as to encompass all such modifications as well as all relationships equivalent to those illustrated in the drawings and described in the specification.

Finally, it will be appreciated that the purpose of the annexed Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. Accordingly, the Abstract is neither intended to define the invention or the application, which only is measured by the claims, nor is it intended to be limiting as to the scope of the invention in any way.

What is claimed as being new and desired to be protected by Letters Patent of the Unitd States is as follows:

1. A step apparatus for use a vehicle tire, comprising:
a first step assembly which includes a first step portion and a pair of first struts extending upward from said first step portion,
a second step assembly which includes a second step portion, a pair of first bracket members partially supporting said second step portion, and a pair of second bracket members adjustably connected to said pair of first bracket members,
hinge members connected between said first struts and said front bracket portions,
a pair of pawl assemblies connected to said rear bracket portions, and
locking means for locking said first bracket members with respect to said second bracket members.

2. The apparatus of claim 1 wherein said pair of second bracket members are telescopically received in said pair of first bracket members.

3. The apparatus of claim 1 wherein said locking means include a locking bolt and a locking nut.

4. The apparatus of claim 1 wherein each of said first struts includes a stop member for contacting the tire when the apparatus is installed on the tire.

5. The apparatus of claim 1 wherein each of said pawl assemblies includes a pawl bias spring connected between said rear bracket portion and said pawl plate.

6. The apparatus of claim 5 wherein each pawl plate includes pawl teeth located on an outside edge of said pawl plate.

7. The apparatus of claim 5 wherein each pawl plate includes a pawl handle for manually operating said pawl plate.

8. The apparatus of claim 7 wherein each of said bias springs is connected between a respective pawl handle and a respective stop member.

9. The apparatus of claim 1, further including:
a third step assembly connected to said first step assembly by means of additional hinge members.

10. The apparatus of claim 9 wherein said third step assembly includes a third step portion and a pair of second struts extending upward from said third step portion.

11. The apparatus of claim 9 wherein said third step assembly includes second stop members attached to said first struts of said first step assembly.

12. The apparatus of claim 9, further including:
a fourth step assembly connected to said third step assembly by means of additional hinge members.

13. The apparatus of claim 12 wherein said fourth step assembly includes a fourth step portion and a pair of third struts extending upward from said fourth step portion.

14. The apparatus of claim 13 wherein said fourth step assembly includes third stop members attached to said second struts of said third step assembly.

15. The apparatus of claim 1, further including:
step-to-wheel support members connected to said first step assembly.

16. The apparatus of claim 15, further including:
a wheel and tire spanning bar connected to said step-to-wheel support members.
